(19) United States
(12) Patent Application Publication
(10) Pub. No.: US 2014/0247430 A1
(43) Pub. Date: Sep. 4, 2014

(54) IMAGE DISPLAY SYSTEM

(71) Applicant: PANASONIC CORPORATION, Osaka (JP)

(72) Inventors: Masahiro INOUE, Osaka (JP); Tetsuro MIZUSHIMA, Kumamoto (JP)

(73) Assignee: PANASONIC CORPORATION, Osaka (JP)

(21) Appl. No.: 14/171,176

(22) Filed: Feb. 3, 2014

(30) Foreign Application Priority Data
Mar. 1, 2013 (JP) 2013-040473

(51) Int. Cl. G02B 27/48; G02B 26/08; H04N 9/31

(52) U.S. Cl. CPC G02B 27/48; H04N 9/3161; G02B 26/0833
USPC 353/33; 353/38

(57) ABSTRACT

In an image display system, a light distribution forming lens is placed between a laser light source and a spatial light modulator or a MEMS mirror device for adjusting a distribution of light intensity of the laser light so that light intensity at an exit pupil of a projection lens is greater in a radially intermediate part thereof than in a central part thereof. The light distribution lens is provided with a conical incident surface and a convex exit surface so as to function also as a collimator lens. Thereby, the image display system can be constructed as a highly compact unit that is highly efficient in the use of available light and free from the problem of speckle noises.

### TECHNICAL FIELD

The present invention relates to an image display system using laser light sources.

### PRIOR ART

There has been a growing trend to use laser light as light sources for image display systems. Laser light sources are known to have various advantages over mercury lamps and light emitting diodes in having a high color purity (which is desirable in accurately reproducing various colors), a capability to be rapidly turned on and off, a long service life, a high power efficiency and a high directivity, in addition to being highly compact in size. See JP2003-098476A, for instance.

The projector is one form of such image display systems, and is typically provided with three light sources for different colors, a modulator for modulating the lights of different colors from these light sources according to a video signal, and an optical system for projecting the modulated and combined light onto a screen. The optical system typically comprises a combining optical system including such components as a collimator lens and a cross prism, an illuminating optical system including such components as a fly eye lens and a condenser lens, and a projection optical system including a projection lens for projecting an image onto a screen. The modulator typically consists of such devices as a spatial light modulator device and a scan type MEMS minor.

As the laser light produced by the laser light sources is highly coherent, speckle noises may be created. Speckle noises are perceived as glittering particles, and are produced when coherent laser light is scattered, causing irregular interferences of the scattered laser light. Speckle noises can seriously degrade image quality.

In particular, small image display systems which use relatively small optical systems are prone to speckle noises because of the limited spatial spread of the laser light. Also when laser light having a relatively narrow spectral band, when a single laser source is used, and when a number of small laser light sources having similar spectral bands are combined, interferences of the laser light are relatively pronounced so that the severity of speckle noises is more likely to increase.

The speckle noises of an image display system using laser light sources can be reduced by increasing the spatial spread of the laser light (F value). However, in a small image display system, because the spatial spread of the laser light is restricted, it is highly difficult to reduce the speckle noises to a desired level.

Various proposals have been made with the aim of reducing speckle noises in image display systems using laser light sources.

The laser projector disclosed in JP2003-98476A comprises a moving diffuser, in addition to beam shaping optics, a laser light source, a beam expander and a spatial light modulator. Owing to the combination of the beam shaping optics with the moving diffuser, the spatial light modulator can be evenly illuminated so that the speckle noises can be reduced.

However, this prior laser projector requires a relatively large optical system (as large as the optical system for a lamp light source), and is therefore unsuitable for use in small image display systems. Furthermore, the extent of the reduction in speckle noises is not satisfactory for some applications.

JP2011-180281A proposes the use of a light diffuser for homogenizing the spatial distribution of the light intensity at the exit pupil so that the speckle noises may be reduced by the homogenization of the light intensity distribution. However, the use of the light diffuser in the optical path prevents the entire use of the available light, and some loss in the use efficiency of the available light is inevitable. Also, as homogenization of light alone is not adequate for a substantial reduction in speckle noises, this prior proposal leaves a lot to be desired. Furthermore, the need for the light diffuser adds to the size and cost of the image display system.

### SUMMARY OF THE INVENTION

In view of such problems of the prior art, a primary object of the present invention is to provide a compact image display system that is highly efficient in the use of available light and free from the problem of speckle noises.

According to a first aspect of the present invention, the image display system comprises a laser light source configured to emit laser light; a spatial light modulator for generating video light by modulating the laser light according to a given video signal; a projection lens for projecting the video light onto a screen; and a light distribution forming lens placed between the laser light source and the spatial light modulator for adjusting a distribution of light intensity of the laser light so that light intensity at an exit pupil of the projection lens is greater in a radially intermediate part thereof than in a central part thereof.

In this case, the system may further comprise a fly eye lens placed between the light distribution forming lens and the spatial light modulator for evenly illuminating the spatial light modulator with the laser light, the spatial light modulator causing a greater intensity of the laser light in a radially intermediate part than in a central part at the fly eye lens.

Preferably, the laser light made incident to the fly eye lens has a peak light intensity at a prescribed distance from an optical center line at an incident surface of the fly eye lens, and has a substantially constant intensity at the prescribed distance from the optical center line at the incident surface of the fly eye lens substantially over an entire circumference. According to a particularly preferred embodiment of the present invention, the light intensity diminishes as one moves radially inward from a region of the peak light density, and moves radially outward from the region of the peak light density.

For multi-color display, the system may comprise a plurality of laser light sources for different colors, a light distribution forming lens provided for each laser light source, and a cross prism configured to combine laser light exiting the light distribution forming lenses.

According to a second aspect of the present invention, the image display device comprises a laser light source for emitting laser light; a MEMS mirror device for generating video light by modulating the laser light; a projection lens for projecting the video light onto a screen; and a light distribution forming lens placed between the laser light source and the MEMS mirror device for adjusting a distribution of light intensity of the laser light such that an intensity in a radially intermediate region of the laser light is greater than that in a radially central region of the laser light at a beam waist of the laser light.

Preferably, the laser light at the beam waist has a peak light intensity at a prescribed distance from an optical center line, and has a substantially constant intensity at the prescribed distance from the optical center line substantially over an entire circumference. According to a particularly preferred embodiment of the present invention, the light intensity diminishes as one moves radially inward from a region of the peak light density, and moves radially outward from the region of the peak light density.

For multi-color display, the system may comprise a plurality of laser light sources for different colors, a light distribution forming lens provided for each laser light source, and a dichroic mirror device configured to combine laser light exiting the light distribution forming lenses.

According to a particularly preferred embodiment of the present invention, the light distribution forming lens is provided with a conical surface on at least one of the incident and exiting surfaces. Most preferably, the light distribution forming lens is provided with a concave conical surface facing the laser light source and an aspheric convex surface facing the spatial light modulator so that the light distribution forming lens is configured to convert the laser light into a parallel beam.

It is known that the magnitude of speckle noises is proportional to the spatial coherence of the laser light that can be computed by Fourier transformation of the light intensity distribution of the laser light. For instance, for a given intensity of laser light, the broader the light intensity distribution is, the smaller the spatial coherence becomes, and hence the smaller the magnitude of speckle noises becomes. In other words, even when the laser light spatially spreads from the light source by a given extent (has a same F value), the level of speckle noises varies depending on the width of the light intensity distribution. The light intensity distribution of laser light is typically Gaussian, but the speckle noises can be reduced by placing a light diffuser in the optical path and thereby homogenizing the distribution of the intensity of the laser light as proposed in JP2011-180281A.

According to a certain aspect of the present invention, the light intensity distribution at the exit pupil of the projection lens is such that the light intensity in a radially intermediate region of the pupil is greater than that in the center of the pupil, or such that a doughnut shaped light intensity distribution is achieved. As a result, the coherence of the illuminating light at the pupil region is reduced so that the speckle noises are reduced.

As compared to the case of the usual Gaussian distribution of the light intensity centered around the optical center line at the exit pupil of the projection lens, the doughnut shaped distribution of the laser light intensity (where the light intensity in a radially intermediate region is greater than that at the center) at the exit pupil causes a relatively small coherence of the laser light for the given F value. As a result, the speckle noises which are caused by locally amplified light intensity can be minimized

According to another aspect of the present invention, a scan type MEMS mirror is used, and the light intensity distribution of the laser light at the beam waist is controlled such that the light intensity in a radially intermediate region is greater than that in the center, or such that a doughnut shaped light intensity distribution is achieved with the result that the coherence at the beam waist is reduced and the speckle noises are reduced.

According to yet another aspect of the present invention, the doughnut shaped distribution of light intensity is achieved by an existing optical device such as a condenser for converting the laser light into a parallel beam so that the speckle noises can be reduced without impairing the use efficiency of the laser light and without increasing the number of component parts.

In short, the image display system of the present invention allows the system to be constructed as a highly compact unit that can reduce speckle noises with a minimal reduction in use efficiency of the laser light by achieving a doughnut shaped distribution of laser light intensity at a suitable point of the optical path such as the exit pupil of the projection lens and the beam waist position (when a scan type MEMS minor is used).

### BRIEF DESCRIPTION OF THE DRAWINGS

FIG. 1 is a diagram showing the overall structure of an image display system given as a first embodiment of the present invention;

FIG. 2 is a diagram showing a light distribution forming lens and a fly eye lens of the image display system;

FIG. 3 is a two dimensional graph showing the intensity distribution of laser light created by the light distribution forming lens at the fly eye lens;

FIG. 4 is a three dimensional graph showing the intensity distribution of laser light created by the light distribution forming lens at the fly eye lens;

FIG. 5 is a view similar to FIG. 2 showing a conventional arrangement;

FIG. 6 is a two dimensional graph showing the intensity distribution of laser light at the fly eye lens in the conventional arrangement;

FIG. 7 is a three dimensional graph showing the intensity distribution of laser light at the fly eye lens in the conventional arrangement;

FIG. 8 is a view similar to FIG. 4 showing the intensity distribution of laser light at the fly eye lens according to a modification of the first embodiment of the present invention;

FIG. 9 is a detailed side view of the light distribution forming lens according to the present invention;

FIGS. 10a and 10b are diagrams showing the light path patterns in the light distribution forming lenses of two different configurations;

FIG. 11 is a graph comparing the magnitudes of speckle noises of the present invention and the prior art;

FIG. 12 is a diagram showing the overall structure of an image display system given as a second embodiment of the present invention;

FIG. 13 is a diagram showing a light distribution forming lens and a fly eye lens of the image display system of the second embodiment; and

FIG. 14 is a two dimensional graph showing the intensity distribution of laser light created by the light distribution forming lens at the beam waist in the second embodiment.

### DETAILED DESCRIPTION OF THE EMBODIMENT(S)

### First Embodiment

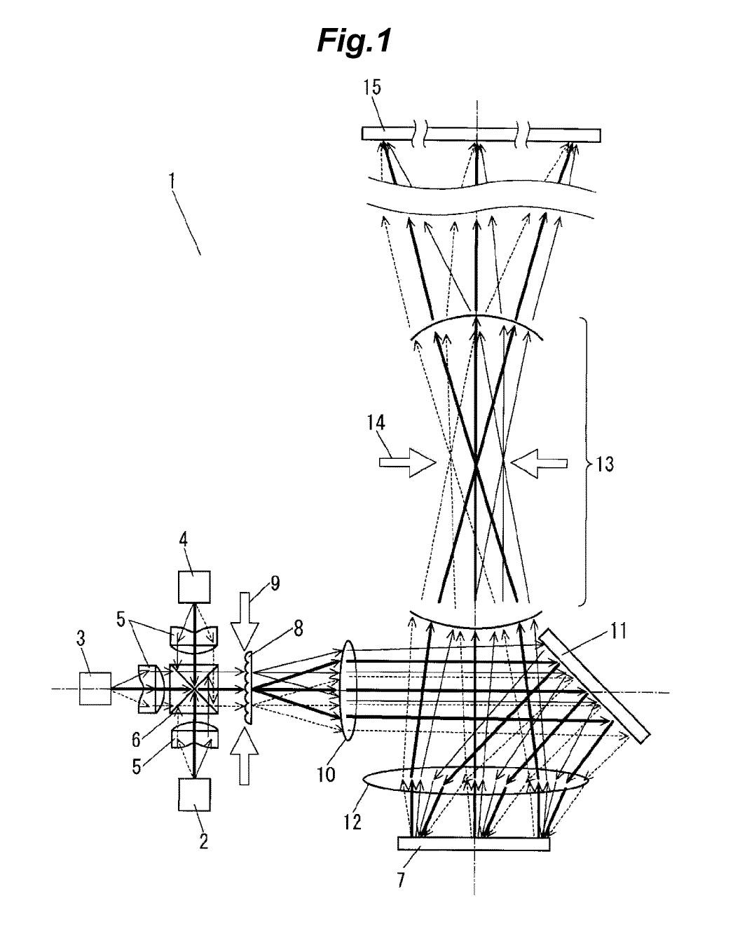

Now the present invention is described in the following in more detail in terms of concrete embodiments with reference to the appended drawings. FIG. 1 shows an image display system given as a first embodiment of the present invention.

This image display system 1 is configured to project a desired image onto a screen 15 (which may be part of the image display device or external thereto), and comprises a red laser light source 2 for producing red laser light (of a wavelength of 655 nm, for instance), a green laser light source 3 for producing green laser light (of a wavelength of 532 nm, for instance) and a blue laser light source 4 for producing blue laser light (of a wavelength of 445 nm, for instance). The laser lights of the different colors are combined by a cross prism 6, and the combined laser light is forwarded to a spatial light modulator 7 for modulating the laser light according to a given video signal, via a fly eye lens 8 and a condenser lens 10 for evenly directing the combined laser light, a reflective mirror 11 for deflecting the direction of the laser light as it propagates from the condenser lens 10, and a field lens 12 for directing the laser light reflected by the reflective mirror 11 onto the spatial light modulator 7 as a parallel beam. The laser light reflected by the spatial light modulator 7 and therefore carrying the video signal is projected onto the screen 15 via the field lens 12 and a projection lens 13.

The image display system 1 uses the field sequential process for displaying color images. More specifically, the laser light of various colors are produced from the corresponding laser light sources 2, 3 and 4 in a time sharing sequence so that the viewer perceives it as a multi-color image owing to the afterimage effect. The spatial light modulator 7 includes numerous small mirrors which are selectively actuated by the video signal such that only the light required for the prescribed image to be displayed on the screen may be reflected. In addition to those using small mirrors, there are those that use a reflective or transmissive liquid crystal device.

In FIG. 1, the light of each color is represented by a center beam and a pair of side beams which are indicated by a bold line, a thin line and a dotted line, respectively. The laser light of each color is passed through a light distribution forming lens 5 to be converted into a parallel beam before propagating to the cross prism 6. The cross prism 6 is constructed so that light of a prescribed wavelength may be transmitted or reflected depending on the incident angle of the input light. In particular, the cross prism 6 is configured so that the red, green and blue laser light from the respective laser light sources 2, 3 and 4 may be combined. The fly eye lens 8 homogenizes the combined light before the combined light is forwarded to the condenser lens 10 to evenly illuminate the spatial light modulator 7 via the reflective mirror 11 and the field lens 12.

The field lens 12 converts the illuminating light into a parallel beam so that the size of the optical system may be minimized

At the fly eye lens position 9, the combined laser light is emitted as a diverging beam which is represented by a combination of a central beam and a pair of side beams each having a distinct imaginary light source as shown in FIG. 1 for the convenience of illustration. FIG. 1 shows an exit pupil position 14 of the projection lens 13, and the imaginary light sources given as point light sources at the fly eye lens position 9 form the images at this exit pupil position 14.

As the exit pupil position 14 of the projection lens 13 is at the conjugate point to the fly eye lens position 9, the intensity distribution of the light incident to the fly eye lens 8 is reproduced or repeated at the exit pupil position 14 of the projection lens 13. Therefore, the intensity distribution of the laser light at the exit pupil position 14 of the projection lens 13 can be controlled by changing the intensity distribution of the laser light at the fly eye lens position 9.

The positioning of the laser light sources of the three colors shown in FIG. 1 is only an example, and can be arranged in variously different ways by suitably selecting the transmissive and reflective properties of the cross prism for the three colors.

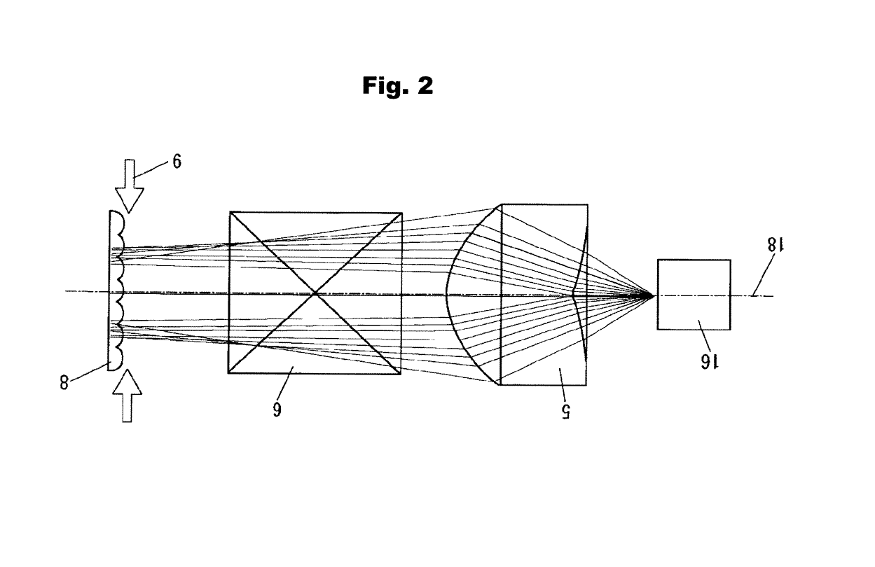

FIG. 2 shows one of the light distribution forming lenses 5, the cross prism 6 and the fly eye lens 8 of the image display system shown in FIG. 1 in an enlarged scale. FIG. 2 shows only one of the light distribution forming lenses 5 for the laser light of one particular color as they are all similar in structure. The light distribution forming lens 5 is provided with a concave conical surface concentric to the optical center line 18 and facing the laser light source 16. In the illustrated embodiment, the opposite surface of the light distribution forming lens 5 facing the cross prism 6 is provided with a preferably aspheric convex surface. Thus, the laser light emitted from the laser light source 16 is not only turned into a parallel beam in parallel with the optical axial line 18 but is also given with a controlled light intensity distribution. In the illustrated embodiment, the light intensity is amplified in an annular region concentric to the optical axial line as compared to the central region adjacent to the optical axial line 18 and the outer peripheral region. In other words, the laser light has a peak light intensity at a prescribed distance from the optical center line 18, and has a substantially constant intensity at the prescribed distance from the optical center line over an entire circumference. Furthermore, the light intensity diminishes as one moves radially inward from the region of the peak light density, and moves radially outward from the region of the peak light density.

Conventionally, a collimator lens was interposed between a laser light source and a cross prism solely for the purpose of turning the laser light into a parallel beam. According to the illustrated embodiment, very little light reaches the central region of the fly eye lens 8, and most of the light that passes through the fly eye lens 8 is concentrated in a concentric doughnut shaped region.

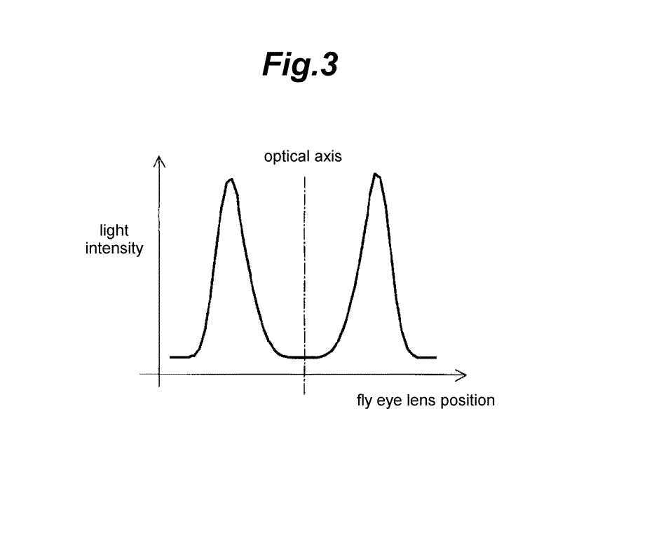

FIG. 3 shows the distribution of light intensity at the fly eye position. The light intensity is at the lowest level in the center and the outer peripheral region, and is higher in the intermediate annular region substantially in a Gaussian distribution. A similar light intensity distribution is achieved also at the exit pupil position 14 of the projection lens 13. This contributes to the reduction of speckle noises as will be discussed hereinafter.

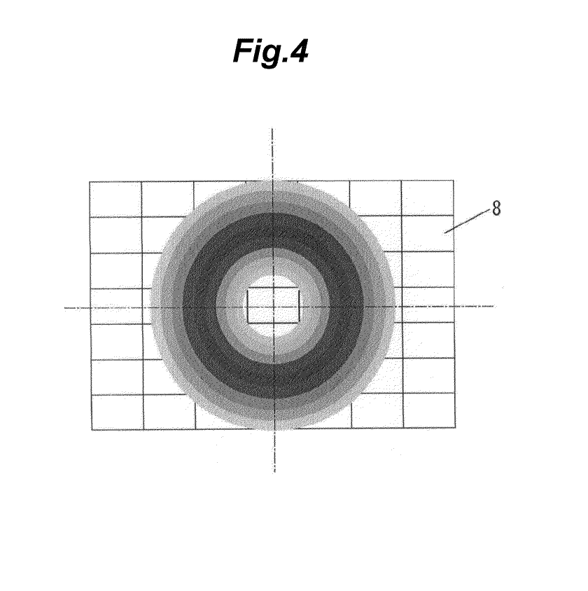

FIG. 4 is a three dimensional graph showing the distribution of the light intensity at the fly eye position 9 produced by the light distribution forming lens 5. The darker area denotes a higher light intensity. The doughnut shaped distribution of light intensity is clearly visible from FIG. 4.

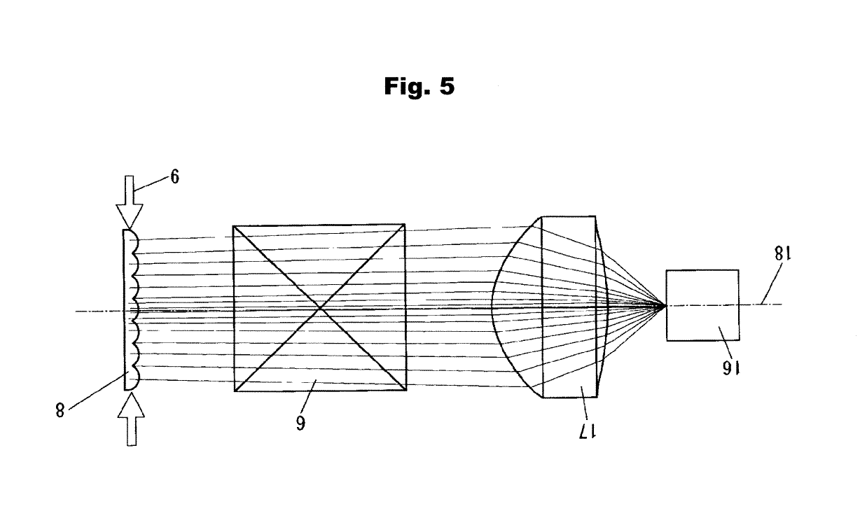

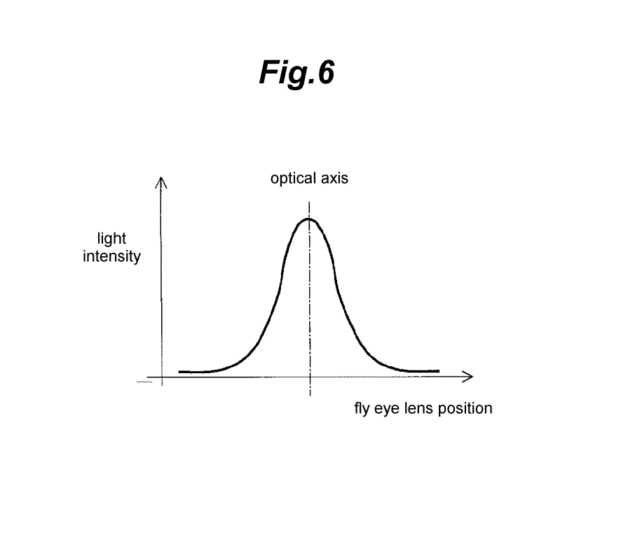

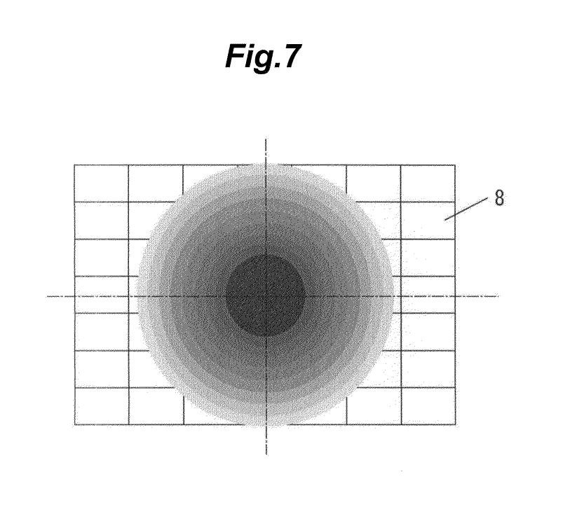

FIG. 5 is a view similar to FIG. 2 showing a conventional arrangement where a normal collimator lens 17 is placed between the laser light source 16 and the cross prism 6. According to this conventional arrangement, the distribution of light intensity is generally Gaussian with the peak located at the optical center line 18 as shown by the graphs of FIGS. 6 and 7.

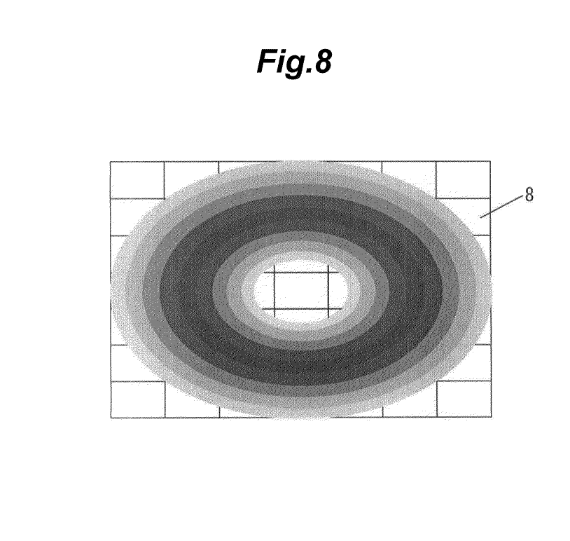

FIG. 8 is a graph similar to FIG. 4 showing the distribution of laser light that is achieved by a modified embodiment of the present invention. In this case, the light distribution forming lens 5 is configured such that an annular Gaussian distribution which is elongated in a prescribed direction can be achieved. In other words, in this embodiment, the region of peak light intensity extends along an ellipse.

The configuration and material of the light distribution forming lenses 5 are discussed in the following.

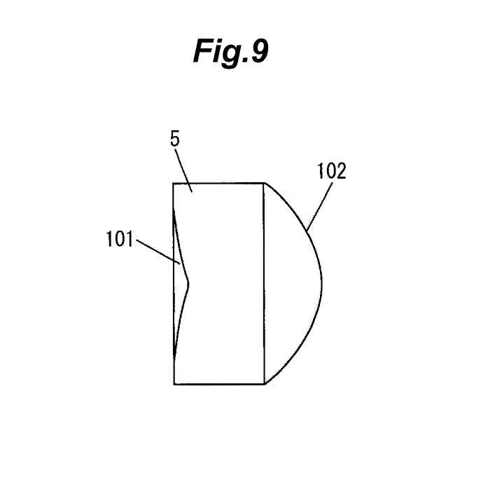

FIG. 9 is a sectional side view of the light distribution forming lens 5 of the first embodiment, and this lens is provided with a first optical surface 101 consisting of a concave conical surface and a second optical surface 102 consisting of an aspheric convex surface. In the illustrated embodiment, the laser light is made incident to the first optical surface 101, and leaves the second optical surface 102. The light distribution forming lens 5 performs the function thereof owing to the refractive properties thereof. The material of this lens has a refractive index of (nd =) 1.512 and an Abbe number of (v=) 56.58 which gives a measure of dispersion, and may be made of any transparent material such as glass and plastics.

The first optical surface 101 or the concave conical surface has a radius of curvature of −0.03167 and a lens radius of 1.2 mm The second optical surface 102 or the (preferably aspheric) convex surface has a radius of curvature of −1.0272063 and a lens radius of 1.6 mm The thickness of the lens at the center is 3.033 mm

The conic coefficients and the aspheric coefficients of the first optical surface 101 or the concave conical surface and the second optical surface 102 or the convex surface are given by the following table.

| | | 1st surface 101 | 2nd surface 102 |
|---|---|---|---|
| Conic coefficient | ε | −5.82 | −2.3373 |
| Aspheric | A2 | 0 | 0 |
| coefficients | A4 | 0.4227 | −0.0268 |
| | A6 | −0.3902 | −0.0193 |
| | A8 | 0.1265 | 0.00806 |
| | A10 | −0.00959 | −0.00109 |

By thus forming the convex surface as an aspheric surface, the light distribution forming lens 5 is enabled not only to achieve a doughnut shaped light intensity distribution but also to convert the laser light into a parallel beam.

Although other configurations are possible, a particularly favorable result can be achieved when the light distribution forming lens 5 is provided with a concave conical surface facing the laser light source and a convex surface facing the spatial light modulator.

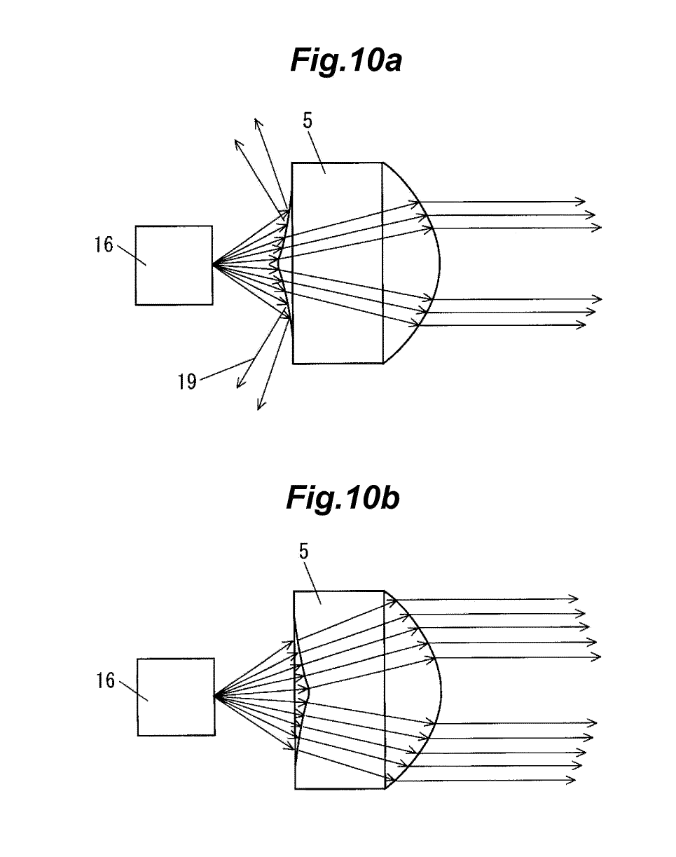

FIGS. 10a and 10b are diagrams showing the light path patterns in the light distribution forming lenses 5 of two different configurations.

The first optical surface 101 may also consist of a convex conical surface as shown in FIG. 10a, instead of a concave conical surface as shown in FIG. 10b. Using a convex conical surface is disadvantageous in increasing the overall thickness of the light distribution forming lens 5 but also in diminishing the use efficiency of the available laser light owing to the overall increase in the incident angle. In other words, a part of the laser light incident to the convex conical surface is reflected to an increased extent as indicated by numeral 19. It is therefore more advantageous to use the concave conical surface which is more efficient in use efficiency of the available laser light owing to the overall decrease in the incident angle as illustrated in FIG. 10b.

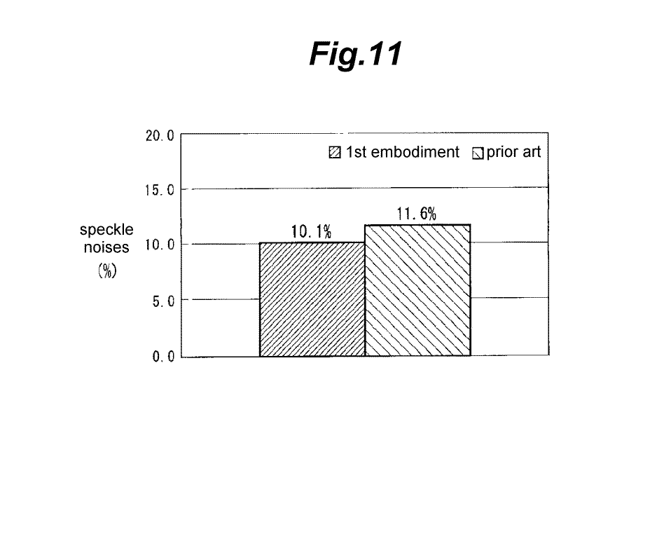

FIG. 11 shows a graph comparing the levels of speckle noises in the image display system of the illustrated embodiment using the light distribution forming lens 5 and the conventional image display system using the collimator lens 17 as illustrated in FIG. 5. The illustrated embodiment can achieve a reduction of speckle noises by 10% as compared to the prior art.

The configuration and the material of the light distribution forming lenses 5 of the illustrated embodiment are only exemplary, and can be varied freely without departing from the spirit of the present invention. For instance, according to a basic concept of the present invention, the conical surface for the first optical surface 101, be it concave or convex, may not only consist of a purely conical surface (with a linear profile) but also consist of somewhat convex or concave conical surface (with a convex or concave profile) without departing from the spirit of the present invention.

### Second Embodiment

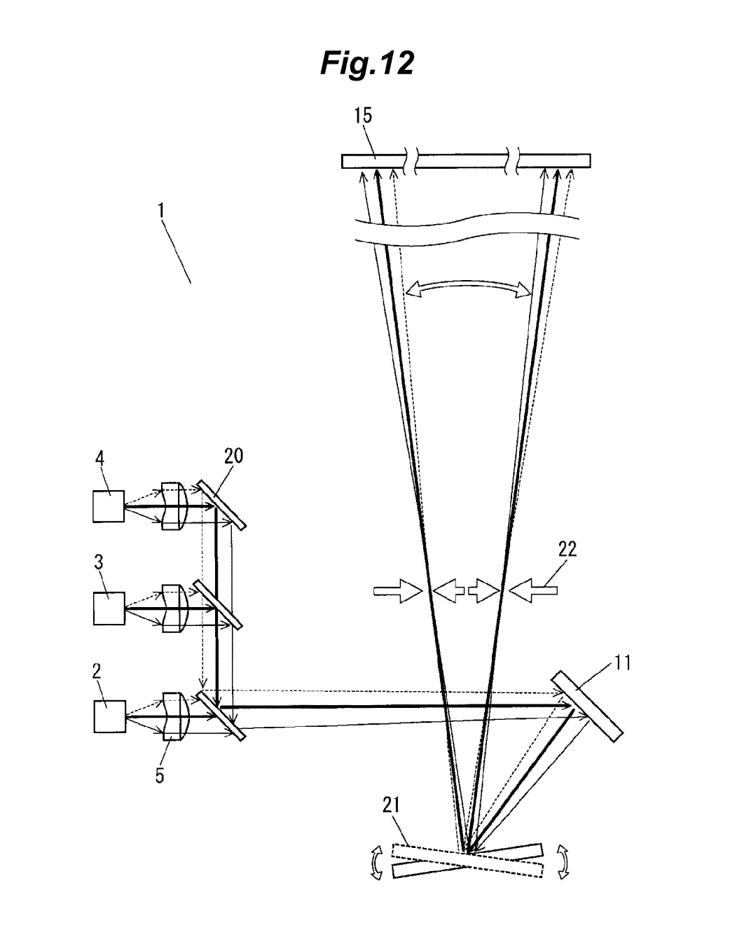

FIG. 12 shows an image display system given as a second embodiment of the present invention. In the description of the second embodiment, the parts corresponding to those of the first embodiment are denoted with like numerals without necessarily repeating the description of such parts.

This image display system 1 is configured to project a desired image onto a screen 15 (which may be part of the image display device or external thereto), and comprises a red laser light source 2 for producing red laser light (of a wavelength of 655 nm, for instance), a green laser light source 3 for producing green laser light (of a wavelength of 532 nm, for instance) and a blue laser light source 4 for producing blue laser light (of a wavelength of 445 nm, for instance). The laser lights of the different colors are combined by a dichroic mirror device 20, and the combined laser light is forwarded to a MEMS minor device 21 including a small minor that can be angularly actuated according to a video signal. The overall optical system is configured such that a laser beam waist 22 is formed at a part of the optical path adjacent to the MEMS minor device 21.

The laser light combined by the dichroic minor device 20 is forwarded to the MEMS minor device 21 via a reflective minor 11, and is two-dimensionally scanned by the MEMS minor device 21. The desired image can be projected onto the screen 15 by synchronizing the scanning action of the MEMS minor device 21 with the modulation of the intensity of the laser light. The actuation of the MEMS minor device 21 can be accomplished by using such means as electrostatic force, Lorenz force (electromagnetic force) and piezo electric force.

In FIG. 12, the light of each color is represented by a center beam and a pair of side beams which are indicated by a bold line, a thin line and a dotted line, respectively. The laser light of each color is passed through a light distribution lens 5 to be converted into a parallel beam before propagating to the dichroic minor device 20. The dichroic mirror device 20 is constructed so that light of a prescribed wavelength may be transmitted or reflected depending on the incident angle of the input light. In particular, the dichroic minor device 20 is configured so that the red, green and blue laser light from the respective laser light sources 2, 3 and 4 may be combined.

The combined laser light illuminates the MEMS minor device 21 including a small minor whose angular position can be varied at high speed so that a two dimensional image can be formed on the screen 15 by scanning the projected laser beam.

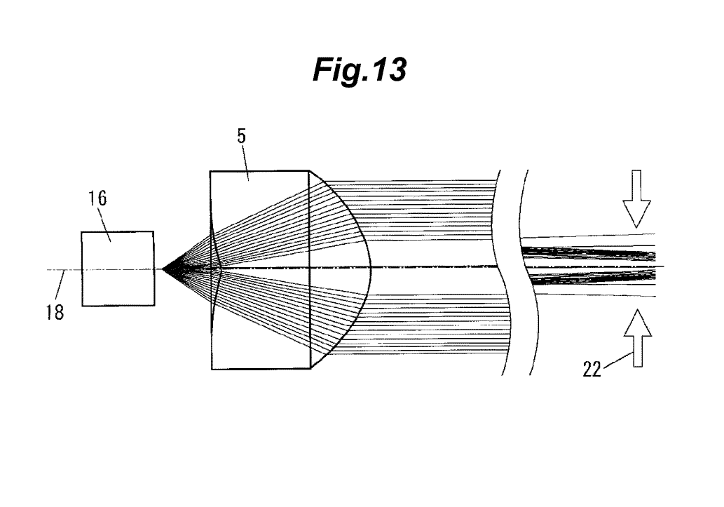

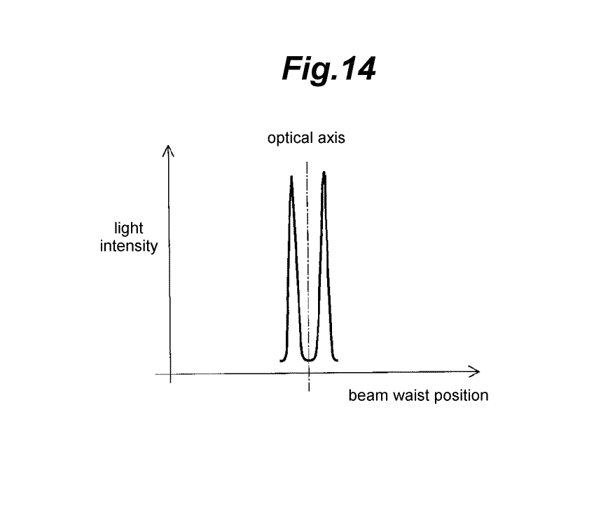

The combined light is converted into a substantially parallel beam by the light distribution lens 5, however, so as to form a beam waist 22 where the spread of the laser light is minimized As shown in FIGS. 13 and 14, at the beam waist 22, the light intensity in a radially intermediate region is greater than that in the central region and the outer peripheral region, or such that a doughnut shaped light intensity distribution is achieved.

By thus producing a doughnut shaped light intensity distribution at the beam waist, the speckle noises can be reduced.

The positions of the laser light sources for the three different colors can be freely arranged relative to one another. By suitably selecting the transmissive and reflective properties of the dichroic mirror device 20 for the three different colors, the arrangement of the light sources can be selected at will. The configuration and the material of the light distribution forming lenses 5 of the illustrated embodiment are only exemplary, and can be varied freely without departing from the spirit of the present invention.

FIG. 13 is an enlarged view of a part of FIG. 12 showing the light path pattern at one of the light distribution forming lenses 5 and the beam waist 22 in greater detail. FIG. 12 shows only one of the three light sources 2, 3 and 4 as a light source 16 because the three light sources are essentially the same in structure except for the color of the laser light. The laser light emitted from the light source 16 is not only converted into a parallel beam in parallel with the optical axial line 18 but also caused to demonstrate a doughnut shaped light intensity distribution at the beam waist 22 by the light distribution forming lens 5. In the conventional arrangement, a collimator lens 17 having only the function to convert the laser light into a parallel beam was used in this position of the optical system, instead of the light distribution forming lenses 5.

FIG. 14 shows the distribution of light intensity at the beam waist 22 owing to the use of the light distribution forming lens 5. The abscissa indicates the radial position and the ordinate indicates the light intensity. The light intensity takes the lowest value at the optical center and an outer peripheral part, and takes a peak value at a prescribed radial distance from the optical center. The radial distribution of the light intensity is typically Gaussian having the maximum value at the prescribed distance. By thus producing a doughnut shaped light intensity distribution at the beam waist 22, the speckle noises can be reduced.

Thus, according to the present invention, by producing a doughnut shaped light intensity distribution at the exit pupil of the projection lens, the speckle noises can be reduced and the loss of light energy can be minimized while the system can be constructed as a highly compact unit.

The present invention was described in terms of specific embodiments, but the present invention is not limited by the illustrated embodiments, and can be changed in various parts thereof without departing from the spirit of the present invention. For instance, instead of being doughnut shaped, the intensity distribution of the laser light may be characterized by a zero or low intensity in a central region and a relatively high intensity over the entire remaining region (at the exit pupil or at the beam waist) if desired. The contents of the original Japanese patent application on which the Paris Convention priority claim is made for the present application as well as the contents of the prior art references mentioned in this application are incorporated in this application by reference.

1. An image display system, comprising:
a laser light source configured to emit laser light;
a spatial light modulator for generating video light by modulating the laser light according to a given video signal;
a projection lens for projecting the video light onto a screen; and
a light distribution forming lens placed between the laser light source and the spatial light modulator for adjusting a distribution of light intensity of the laser light so that light intensity at an exit pupil of the projection lens is greater in a radially intermediate part thereof than in a central part thereof.

2. The image display system according to claim 1, further comprising a fly eye lens placed between the light distribution forming lens and the spatial light modulator for evenly illuminating the spatial light modulator with the laser light, the spatial light modulator causing a greater intensity of the laser light in a radially intermediate part than in a central part at the fly eye lens.

3. The image display system according to claim 2, wherein the laser light made incident to the fly eye lens has a peak light intensity at a prescribed distance from an optical center line at an incident surface of the fly eye lens.

4. The image display system according to claim 3, wherein the laser light made incident to the fly eye lens has a substantially constant intensity at the prescribed distance from the optical center line at the incident surface of the fly eye lens substantially over an entire circumference.

5. The image display system according to claim 3, wherein the light intensity diminishes as one moves radially inward from a region of the peak light density, and moves radially outward from the region of the peak light density.

6. The image display system according to claim 1, wherein the system comprises a plurality of laser light sources for different colors, a light distribution forming lens provided for each laser light source, and a cross prism configured to combine laser light exiting the light distribution forming lenses.

7. The image display system according to claim 1, wherein the light distribution forming lens is provided with a conical surface on at least one of the incident and exiting surfaces.

8. The image display system according to claim 7, wherein the light distribution forming lens is provided with a conical surface facing the laser light source and a convex surface facing the spatial light modulator.

9. The image display system according to claim 8, wherein the conical surface is defined as a concave conical surface.

10. The image display system according to claim 8, wherein the light distribution forming lens is provided with an aspheric convex lens facing away from the conical surface.

11. The image display system according to claim 7, wherein the light distribution forming lens is configured to convert the laser light into a parallel beam.

12. An image display system, comprising:
a laser light source for emitting laser light;
a MEMS minor device for generating video light by modulating the laser light;
a projection lens for projecting the video light onto a screen; and
a light distribution forming lens placed between the laser light source and the MEMS mirror device for adjusting a distribution of light intensity of the laser light such that an intensity in a radially intermediate region of the laser light is greater than that in a radially central region of the laser light at a beam waist of the laser light.

13. The image display system according to claim 12, wherein the laser light at the beam waist has a peak light intensity at a prescribed distance from an optical center line.

14. The image display system according to claim 13, wherein the laser light at the beam waist has a substantially constant intensity at the prescribed distance from the optical center line substantially over an entire circumference.

15. The image display system according to claim 13, wherein the light intensity diminishes as one moves radially inward from a region of the peak light density, and moves radially outward from the region of the peak light density.

16. The image display system according to claim 12, wherein the system comprises a plurality of laser light sources for different colors, a light distribution forming lens provided for each laser light source, and a dichroic mirror device configured to combine laser light exiting the light distribution forming lenses.

17. The image display system according to claim 12, wherein the light distribution forming lens is provided with a conical surface on at least one of the incident and exiting surfaces.

18. The image display system according to claim 17, wherein the light distribution forming lens is provided with a conical surface facing the laser light source and a convex surface facing the spatial light modulator.

19. The image display system according to claim 17, wherein the conical surface is defined as a concave conical surface.

20. The image display system according to claim 17, wherein the light distribution forming lens is provided with an aspheric convex lens facing away from the conical surface.
